(19) United States
(12) Patent Application Publication
(10) Pub. No.: US 2010/0226042 A1
(43) Pub. Date: Sep. 9, 2010

(54) MAGNETIC DISK SUBSTRATE

(75) Inventors: Kenichi Nishimori, Shinjuku-ku (JP); Tadashi Tomonaga, Shinjuku-ku (JP)

Correspondence Address: SUGHRUE MION, PLLC, 2100 PENNSYLVANIA AVENUE, N.W., SUITE 800, WASHINGTON, DC, 20037, US

(73) Assignees: HOYA CORPORATION, Shinjuku-ku ,Tokyo (JP); HOYA GLASS DISK (Thailand ) LTD., Lamphun (TH)

(21) Appl. No.: 12/666,166

(22) PCT Filed: Sep. 1, 2008
(86) PCT No.: PCT/JP2008/065674

§ 371 Date: May 14, 2010

(30) Foreign Application Priority Data
Sep. 4, 2007 (JP) 2007-229160

(51) Int. Cl. G11B 5/82; G11B 5/84

(52) U.S. Cl. 360/135; 427/128; 427/131; G9B/5.293

(57) ABSTRACT

NG surface information obtained in a defect inspecting step of a magnetic disk substrate is depicted on the magnetic disc substrate, so that the information can be discriminated at a succeeding film depositing step.

### TECHNICAL FIELD

The present invention relates to a magnetic disk substrate used in a magnetic disk of a hard disk drive (hereinafter, referred to as an HDD) and a method of manufacturing the magnetic disk substrate, and a magnetic disk using the magnetic disk substrate and a method of manufacturing the magnetic disk.

### BACKGROUND ART

In general, an HDD includes a magnetic disk with a magnetic recording layer of a magnetic thin film formed on a surface of a disk-shaped aluminum or glass substrate, a spindle motor for rotating the magnetic disk at a high speed, a magnetic head attached to the tip of a swing arm to perform magnetic data reading/writing on the magnetic recording layer of the magnetic disk and a positioning device for moving the magnetic head in a radius direction on the magnetic disk as essential constitutional elements. Respective magnetic heads are disposed in opposition to the magnetic recording layers formed on both main surfaces of the magnetic disk and hence two magnetic heads are installed for one magnetic disk.

The magnetic disk has a configuration that base material layers, magnetic layers, protection layers and lubrication layers are sequentially laminated on the both main surfaces of the magnetic disk substrate. The magnetic layer acting as the magnetic recording layer is a ferromagnetic alloy layer of a hexagonal closest packing structure (hcp structure) and contains an expensive material such as a CoPt-based alloy, a CoCrPt-based alloy or the like.

In a magnetic disk substrate manufacturing process, defect inspection is performed on the both main surfaces of the substrate which has been subjected to polishing, cleaning or other step. It is judged whether the size of a defect, the number of defects and others detected in the defect inspection are within ranges defined in a predetermined specification. Even a magnetic disk substrate which has been detected to have a detect not within the range in the specification just only on its one main surface is not judged as an object of end product and excluded from the manufacturing process.

On the other hand, recently, since the disk capacity has been increased, such an HDD is on the market that an expensive magnetic head is disposed only on one side of a magnetic disk to perform magnetic data reading/writing only on a magnetic recording layer on one side of the magnetic disk. If it is allowed to use only the magnetic recording layer on one side of the magnetic disk, it will become possible to use even the magnetic disk substrate as mentioned above which has been detected to have the defect not within the range in the specification just only on its one main surface as an end product. As a result, cost reduction of the HDD can be promoted by reducing the number of expensive magnetic heads and effectively utilizing the magnetic disk substrate which has been detected to have the defect just only on its one main surface.

As related art, for example, there is JP-A-2001-243735 (Patent Document 1) and the like.

[Patent Document 1] JP-A-2002-243735

### DISCLOSURE OF INVENTION

### Problems to be Solved by the Invention

Incidentally, even in the case that it is intended to use a magnetic disk substrate which has been detected to have a defect on its one main surface as an end product, magnetic recording layers are deposited on the both main surfaces of the magnetic disk substrate in a film-depositing process. The expensive material such as the CoPt-based alloy, the CoCr-based alloy or the like is used in the magnetic layer serving as the magnetic recording layer of the magnetic disk. Therefore, it is useless to perform film-deposition even on the substrate surface which has been originally known not to be used as the recording surface by using the expensive material from the viewpoint of cost reduction.

The present invention has been made in view of the above mentioned respect. An object of the present invention is to provide a magnetic disk substrate and its manufacturing method, and a magnetic disk using the magnetic disk substrate and its manufacturing method, allowing sure discrimination of a main surface of the magnetic disk substrate which has been detected to have a defect with which the main surface is judged to be inappropriate as a recorded surface in defect inspection performed in the manufacturing process of the magnetic disk substrate in the succeeding film-depositing process to promote the cost reduction.

### Means for Solving the Problems

The inventors of the present invention have found that the cost reduction is realized by not depositing a film made of an expensive material on a substrate surface (a not-recorded surface) which has been known in advance as a not-used one and have come to accomplish the present invention by constructing a system which can be realized in the above mentioned manner.

According to the present invention, there is provided a magnetic disk substrate manufacturing method comprising an inspecting step of performing surface inspection to judge whether both main surfaces of a magnetic disk substrate meet conditions for forming a recording layer, wherein

with respect to a magnetic substrate in which one main surface meets the conditions and other main surface does not meet the conditions, discriminative information is appended to the other main surface.

According to the above mentioned manufacturing method, the discriminative information is appended to the other main surface of the magnetic disk substrate whose one main surface meets the conditions for forming the recording layer and whose other main surface does not meet the conditions. Therefore, a recorded surface can be discriminated from a not-recorded surface from the information put on the other main surface of the magnetic disk substrate in the succeeding film-depositing process. As a result, such control is made possible to deposit a film made of an inexpensive material which is different from the material of the recorded surface on the not-recorded surface.

Further, according to the present invention, there is provided a magnetic disk substrate manufacturing method comprising an inspecting step of performing surface inspection to judge whether both main surfaces of a magnetic disk substrate meet conditions for forming a recording layer and a packaging step of containing and packaging a plurality of magnetic disk substrates in which one main surfaces meet the conditions and other main surfaces do not meet the conditions in a case for shipment such that the main surfaces that meet the conditions are oriented in the same direction, wherein

in a state that recorded surface information indicating which one of the main surfaces of each substrate is a recorded surface that meets the conditions or not-recorded surface information indicating which one of the main surfaces of each substrate is a not-recorded surface that doe not meet the conditions is appended to the case for shipment, the recorded surface information or the not-recorded surface information is fed to a succeeding film-depositing step.

According to the above mentioned manufacturing method, the case for shipment is fed to the succeeding film-depositing process in the state that the recorded surface information or the not-recorded information is appended to the case. Therefore, in the succeeding film-depositing process, the recorded surface can be discriminated from the not-recorded surface from the information appended to the case for shipment. As a result, such control is made possible to deposit a film made of an inexpensive material which is different from the material of the recorded surface on the not-recorded surface.

Further, according to the present invention, there is provided a magnetic disk substrate manufacturing method comprising an inspecting step of performing surface inspection to judge whether both main surfaces of a magnetic disk substrate meet conditions for forming a recording layer and a packaging step of containing and packaging a plurality of magnetic disk substrates in which one main surfaces meet the conditions and other main surfaces do not meet the conditions in a case for shipment such that the main surfaces that meet the conditions are oriented in the same direction, wherein

the case for shipment is made in advance correspond with recorded surface information indicating which one of the main surfaces of each substrate is a recorded surface that meets the conditions or not-recorded surface information indicating which one of the main surfaces of each substrate is a not-recorded surface that does not meet the conditions, and

the recorded surface information or the not-recorded surface information is fed to a succeeding film-depositing step without being appended directly to the magnetic disk substrate or the case for shipment.

According to the above mentioned manufacturing method, the case for shipment is fed to the succeeding film-depositing process by making the recorded surface information or the not-recorded surface information correspond with the case for shipment in advance. Therefore, in the succeeding film-depositing process, the recorded surface can be discriminated from the not-recorded surface from the information made in correspondence with the case for shipment. As a result, such control is made possible to deposit a film made of an inexpensive material which is different from the material of the recorded surface on the not-recorded surface.

Further, according to the present invention, there is provided a magnetic disk substrate having a recording layer formed on one main surface, wherein
information indicative of a not-recorded surface is appended to one main surface which does not meet conditions for forming a recording layer.

According to the above mentioned magnetic disk substrate, the information indicative of the not-recorded surface is appended to the main surface which does not meet the conditions for forming the recording layer. Therefore, in the succeeding film-depositing process, the recorded surface can be discriminated from the not-recorded surface from the information appended to the magnetic disk substrate. As a result, such control is made possible to deposit a film made of an inexpensive material which is different from the material of the recorded surface on the not-recorded surface.

Further, according to the present invention, there is provided a magnetic disk manufacturing method, comprising:
a grasping step of grasping which one of both main surfaces of a magnetic disk substrate is a recorded or not-recorded surface; and
a film-depositing step of depositing a recording layer on a side of the recorded surface grasped at the grasping step and depositing a dummy layer for balancing film stresses on the both main surfaces on the not-recorded surface.

According to the above mentioned manufacturing method, which one of the both main surfaces of the magnetic disk is the recorded surface is grasped. As a result, such control is made possible to deposit the recording layer on the recorded surface side and the dummy layer for balancing the film stresses exerted on the both main surfaces on the not-recorded surface.

In the aforementioned magnetic disk manufacturing method, in the grasping step, the main surface to be used as the recorded surface may be judged from information appended to the main surface of the magnetic disk substrate. Alternatively, the main surface to be used as the recorded surface may be judged from the recorded surface or not-recorded surface information appended to a case for shipment containing a plurality of magnetic disk substrates. Alternatively, information which is made correspond with a case for shipment containing a plurality of magnetic disk substrates and which is recorded surface information indicating which one of the main surfaces of each substrate is a recorded surface that meets the conditions or not-recorded surface information indicating which one of the main surfaces of each substrate is a not-recorded surface that does not meet the conditions may be obtained from relation with the case for shipment in which the magnetic disk substrate is contained.

In the above mentioned magnetic disk manufacturing method, the film-depositing process features that the dummy layer is deposited on the not-recorded surface by using the material which is more inexpensive than that of the recording layer. Therefore, it is avoided to deposit the film of the expensive material which is the same as that on the recorded surface on the not-recorded surface whose non-use has been originally known and hence the cost reduction can be promoted.

Further, according to the present invention, there is provided a magnetic disk, comprising:
a magnetic disk substrate in which one main surface meets conditions for forming a recording layer and other main surface does not meets the conditions;
a recording layer formed on one main surface of the magnetic disk substrate that meets the conditions; and
a dummy layer formed on the other main surface of the magnetic disk substrate that does not meet the conditions so as to balance film stresses on the both main surfaces.

In this manner, the dummy layer is deposited in order to balance the film stresses on the both main surfaces, instead of deposition of the film of the expensive material which is the same as that on the recorded surface on the not-recorded surface whose non-use has been originally known. Therefore, it becomes possible to prevent the film stresses on the both main surfaces of the magnetic disk from being imbalanced and the cost reduction can be promoted simultaneously.

### ADVANTAGES

The present invention allows sure discrimination of the main surface of the magnetic disk substrate which has been detected to have the inappropriate defect in its magnetic recording layer in the defect inspection performed in the manufacturing process of the magnetic disk substrate in the succeeding film-depositing process. Therefore, the cost reduction can be promoted by avoiding use of the expensive material on the substrate surface which has been originally known not to be used as the recorded surface.

### BRIEF DESCRIPTION OF DRAWINGS

FIG. 1 is a conceptual diagram of a course ranging from a defect inspecting process to a packaging process in a manufacturing process of a magnetic disk substrate according to an embodiment of the present invention.

FIG. 2 is an outside view of a containing cassette case on which recorded surface information is described.

FIG. 3 is a perspective view of forms on which the recorded surface information is described to be appended to the containing cassette case.

FIG. 4 is a conceptual diagram of a sputtering device used in the film-depositing process according to the above mentioned embodiment of the present invention.

### BEST MODE FOR CARRYING OUT THE INVENTION

Next, description will be made on a process of manufacturing a magnetic disk substrate and a film-depositing process of depositing a film on the magnetic disk substrate according to an embodiment of the present invention. In the following description, description will be made on an example in which a glass substrate is used as the magnetic disk substrate. However, the present invention is not limited to the glass substrate and is also applicable to other magnetic disk glass substrates such as an aluminum substrate and substrates of other materials.

The glass substrate manufacturing process includes a grinding process of grinding a raw material to make uniform its board thickness, a polishing process of polishing the surface of the glass substrate to eliminate waviness of the substrate surface and its surface roughness, a chemical-reinforcing process of chemically reinforcing the glass substrate, a cleaning process of controlling dust on the glass substrate and the roughness of the glass substrate, a defect inspecting process of inspecting the surface of the glass substrate for a defect, a packaging process of containing and packaging the glass substrates which have been subjected to final inspection in a containing cassette and the like.

In the above described grinding process, in the case that the substrate is made of disk-shaped press glass, the both surfaces of the substrate are ground to have a predetermined board thickness. Grinding is performed in the following manner. The glass substrate is nipped between upper and lower surface plates and the upper and lower surface plates are rotated in opposite directions to grind the both surfaces of the glass substrate. In the case that the substrate is made of sheet glass which is superior to press glass in board thickness and flatness, such grinding as performed on the substrate made of press glass may not be necessary in some cases. However, in the latter case, the necessity of execution of cutting work to cut the glass substrate into disk-shaped plates of predetermined sizes (ID, OD) generates. In addition, a hole is made in the center of the glass substrate and a disk end face is chamfered and polished.

In the above described polishing process, polish pads are attached to both the upper and lower surface plates and then the glass substrate is nipped between the upper and lower surface plates to polish the substrate. In first polishing, relatively hard pads (for example, urethane pads) are used to flatten the end contour, irregularities and large waviness of the glass substrate. In second polishing, relatively soft pads (for example, urethane foam pads) are used to flatten the surface roughness of the glass substrate and its small waviness. In the second polishing, the substrate is polished to have a target surface roughness of 0.2 to 0.3 nm.

In the above described chemical-reinforcing process, ion-exchange is performed to exchange ions (for example, Li+ and Na+ ions in case of a substrate made of aluminosilicate glass) present on the surface with ions (Na+ and K+ ions) of radii larger than those of the above ions. Ions are exchanged with ions of atoms of larger ion radii to exert a compressive stress on the surface of the glass so as to increase the rigidity of the glass substrate, on the surface of the glass substrate (for example, down to the depth of about 5 μm measured from the glass substrate surface).

In the above mentioned cleaning process, cleaning is performed to remove abrasives and impurities adhered to the surface of the glass substrate. Cleaning methods include physical and chemicals cleaning methods. The physical cleaning method includes scrub-cleaning and ultrasonic cleaning. The chemicals cleaning method includes cleaning performed by etching the glass substrate, cleaning performed using chemicals to dissolve the impurities and abrasives adhered to the glass substrate and cleaning performed by using a surfactant to control the potential. In the cleaning processes performed between the grinding process and the first polishing process and between the first polishing process and the second polishing process, the chemicals cleaning and the ultrasonic polishing are performed in combination.

In the above mentioned detect inspecting process, total inspection and sampling inspection are performed. The total inspection is performed on defects which can be totally inspected and the sampling inspection is performed on defects which cannot be totally inspected. Defects to be inspected for include flaws, stains (particles), material factors and changes in form. In a clean room, inspection is performed by inspecting the surface state of the glass substrate, measuring chamfered angles of the ID and OD and measuring the roundness and the concentricity of the substrate, using an AFM (an inter-atomic force microscope). After cleaning performed at the completion of the second polishing, the glass substrate is carried into the clean room to visually inspect the substrate. In this visual inspection, the glass substrate is inspected as to presence of cracks, adhesion of dust, presence of fissures and crevices, presence of abrasives and the like. The same visual inspection is also performed after cleaning performed at the completion of the chemical-reinforcing process. In the defect inspecting process, it is judged whether the both main surfaces of the glass substrate meet the conditions for forming the recording surface defined in the specification. When the surface concerned meets the conditions in the specification, it is judged to be an “OK surface”, while when it does not meet the conditions in the specification, it is judged to be an “NG surface”. A glass substrate whose both surfaces have been judged to be the “NG surfaces” is excluded from the objects of end products. On the other hand, a glass substrate which has been judged that only one main surface thereof is the “NG surface” is fed to the succeeding film-depositing process as an object of end product.

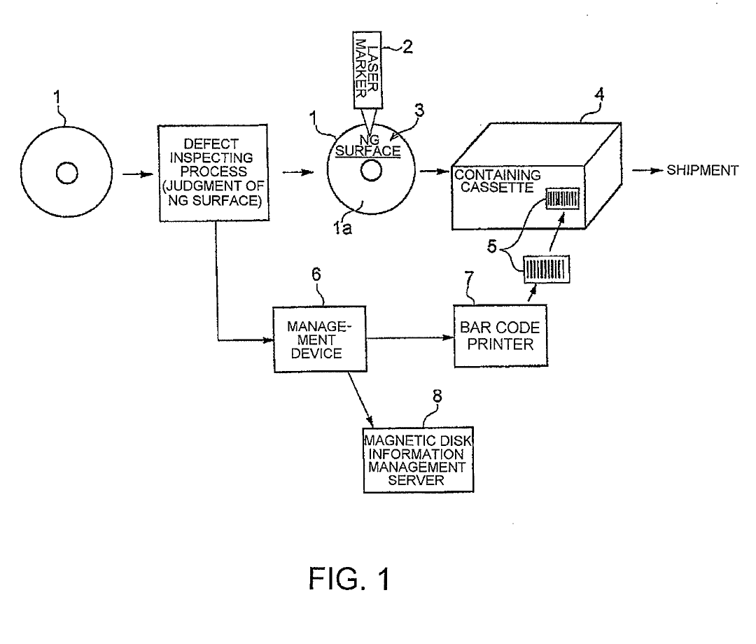

FIG. 1 is a conceptual diagram showing the process of containing the glass substrate which has been judged in the defect inspecting process to have the “NG surface” and to which information which can be discriminated in the succeeding process has been appended. As for a glass substrate 1 whose one main surface meets the conditions in the specification and whose other main surface does not meet the conditions in the specification and hence has been judged to be the “NG surface” in the defect inspecting process, the letter “NG surface” 3 is depicted on its NG surface 1a using a laser marker 2 as information used for discrimination that it does not meet the conditions in the specification. With this letter, which is the recorded surface or the not-recorded surface of the glass substrate 1 can be discriminated in the succeeding film-depositing process. Incidentally, the present invention is not limited to the system of physically appending Index information to the glass substrate 1 using the laser marker 2 and marking may be performed on the glass substrate 1 by magnetic/electric/chemical method. In addition, if it is possible to identify the OK/NG surfaces with no mark on the substrate concerned, marking will not be always necessary.

In the packaging process, the glass substrate 1 which has been judged that only one main surface is the “OK surface” in the defect inspecting process is contained in a containing cassette case 4. Bar code information 5 is appended to the containing cassette case 4 in order to manage the glass substrates contained in the cassette. A management device 6 fetches management information including a result of defect inspection, a serial number and the like of each glass substrate acquired in the defect inspecting process. The management device 6 generates bar code information for tying the glass substrate contained in the containing cassette case 4 with its management information and prints the bar code on a seal form using a bar code printer 7. The seal with the bar code information 5 printed out is stuck on the containing cassette case 4. The management device 6 transmits the management information of the glass substrates contained in the containing cassette case 4 to a magnetic disk information management server 8 for monopolistic management on the side of the server.

Although, in the above mentioned description, the letter “NG surface” 3 is depicted directly on the NG surface 1a of the glass substrate 1, the recorded surface needs only be discriminated from the not recorded surface in the succeeding film-depositing process. Thus, the glass substrate 1 may be transferred to the film-depositing process in a state that it is made in correspondence with its recorded or not-recorded surface information by a method other than the method of directly depicting the information on the glass substrate 1.

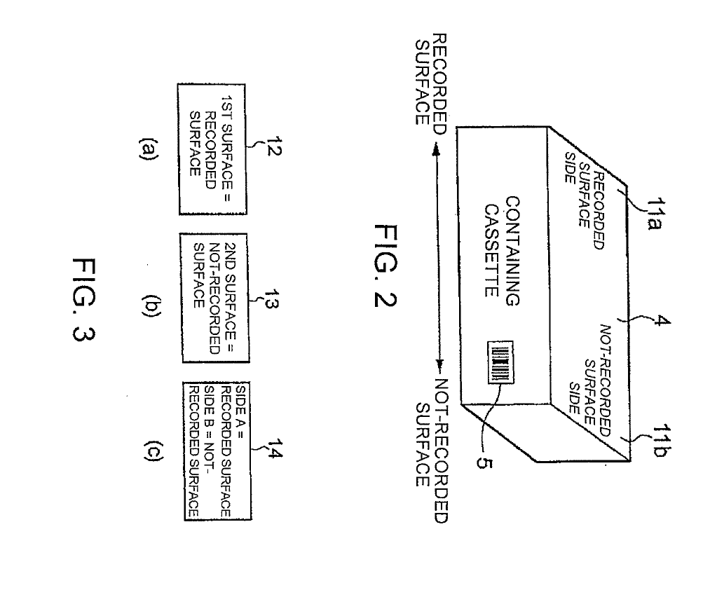

As shown in FIG. 2, each substrate is contained in the containing cassette case 4 with its recorded surface which has been judged to be the “OK surface” in the defect inspecting process oriented in one direction (leftward in the example shown in the drawing). On the surface of the containing cassette case 4, a “recorded surface side” 11a and a “not-recorded surface side” 11b are indicated so as to discriminate the recorded surface side from the not-recorded surface side. As a result, it becomes possible to discriminate the recorded surface from the not-recorded surface on the side of performing the film-depositing process into which the containing cassette case has been carried.

In the case that a first surface of the glass substrate can be discriminated from a second surface with no indication of the “recorded surface side” 11a and the “not-recorded surface side” 11b on the surface of the containing cassette case 4, a form 12 indicating that the first surface is the recorded surface may be appended to the containing cassette case 4 as shown in FIG. 3(a) or a form 13 indicating that the second surface is the not-recorded surface may be appended to the containing cassette case 4 as shown in FIG. 3(b). Alternatively, in the case that one and the other sides of the containing cassette case 4 can be specified respectively as sides A and B, a form 14 indicating that the side A is the recorded surface and the side B is the not-recorded surface may be appended to the case 4 as shown in FIG. 3(c).

Further, the magnetic disk information management server 8 may be configured to manage the recorded surface and/or not recorded surface information of the glass substrate 1 and to make the bar code information 5 correspond with the glass substrate 1. Then, the recorded or not-recorded surface information of the glass substrate 1 may be acquired from the bar code information 5 by gaining access to the magnetic disk information management server 8.

Next, description will be made with respect to the film-depositing process of performing film-deposition on the magnetic disk substrate 1 to produce a magnetic disk.

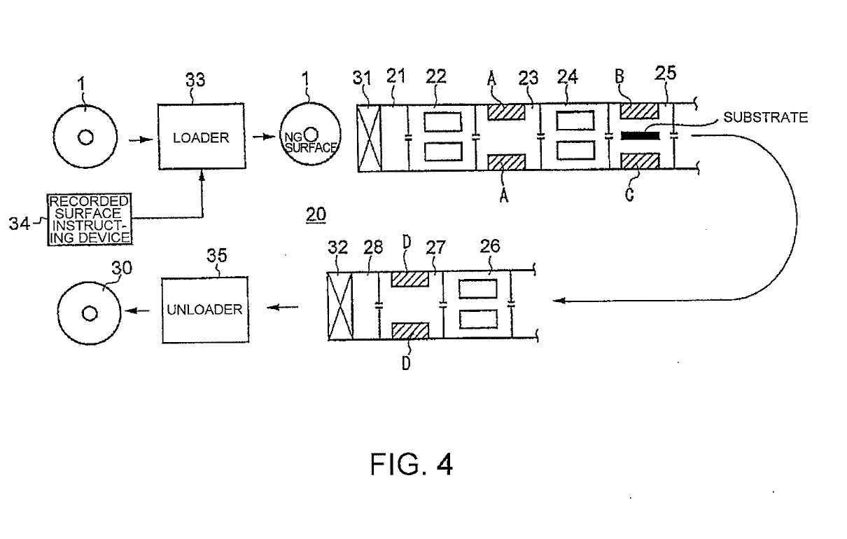

FIG. 4 is a schematic diagram of a sputtering device used to produce a magnetic recording medium in the film-depositing process. The sputtering device shown in the drawing is of an in-line system that sputter deposition is continuously performed simultaneously on both main surfaces of a glass substrate while the glass substrate set on a carrier is being continuously moved. A sputtering device 20 shown in FIG. 4 includes an entrance chamber 21, a heating chamber 22, a first sputter chamber 23, a heating chamber 24, a second sputter chamber 25, a heating chamber 26, a third sputter chamber 27 and an exit chamber 28.

The entrance chamber 21 and the exit chamber 28 respectively have lock valves 31 and 32 so as to insert the glass substrate 1 into the device and to pull a substrate 30 which has been subjected to film-deposition out of the device through the valves. The glass substrate 1 is inserted into the entrance chamber 21 using a loader 33.

The heating chambers 22, 24 and 26 are disposed directly before the respective sputter chambers 23, 25 and 27. Incidentally, FIG. 4 shows no transfer chamber, buffering chamber and slit heater which are integrated with the respective heating chambers 22, 24 and 26.

In the first sputter chamber 23, a base material layer of a metal film is deposited on at least the recorded surface of the substrate. The base material layer has a function to make fine and uniform crystal grains in respective layers which are deposited thereon (a seed layer) or to control crystal orientation in each layer (an orientation control layer). In the example shown in the drawing, targets A are disposed on both sides of a substrate moving path in the first sputter chamber 23. As the target A, CoCr may be used if it is of the hcp structure. In this case, the base material layers are deposited on both the recorded and not-recorded surfaces of the substrate.

In the second sputter chamber 25, film-deposition is performed on the recorded surface of the substrate to form a magnetic layer having a function of recording a magnetically reversed pattern using a magnetic head and to form a dummy layer on the not-recorded surface (the NG surface) of the substrate. A target B is disposed on one side of the substrate moving path in the second sputter chamber 25 to be used to deposit the magnetic layer and a target C is disposed on the opposite side to be used to deposit the dummy layer. As the target B used to deposit the magnetic layer, a CoCr-based alloy ferromagnetic material may be used if it is of the hcp structure and an expensive material such as CoCrPt or CrPtTa is contained. On the other hand, the not-recorded surface needs only finally attain the same film stress as that on the recorded surface side. Therefore, an inexpensive material may be used for the target C used to deposit the dummy layer, instead of the expensive material such as the magnetic film. For example, a Cr target or the like may be used.

In the third sputter chamber 27, a protection layer is deposited on at least the recorded surface of the substrate in order to protect the magnetic film and the magnetic head. A carbon film is generally used as the protection layer. In this example, targets D are disposed on both sides of the substrate moving path in the third sputter chamber 27. Carbon can be used as the material of the target D used to deposit the protection layer. In this case, the protection layers are deposited on both the recorded and not-recorded surfaces of the substrate.

In the above description, film-deposition is performed on the non-recorded surface of the substrate using the same targets A and D as those for the recorded surface. However, further cost reduction may be promoted by using the target for film-deposition on the non-recorded surface of the substrate which is different from that for the recorded surface on condition that it is of the type making uniform the film stresses on the not-recorded and recorded surfaces of the substrate.

The loader 33 is installed at the entrance of the entrance chamber 21. The loader 33 controls to orient the recorded surface of the glass substrate 1 in a predetermined direction in accordance with an instruction from a recorded surface instructing device 34 to set the substrate on the carrier.

Specifically, the orientation of the glass substrate 1 is controlled such that the recorded surface faces the side on which the target B for depositing the magnetic layer is disposed in the second sputter chamber 25. As a result, the magnetic layer is deposited on the recorded surface using the target B and the dummy layer is deposited on the not-recorded surface using the target C upon film-deposition in the second sputter chamber 25.

The recorded surface instructing device 34 is capable of grasping the recorded or not-recorded surface of the glass substrate 1 by any of the following methods. For example, in the case that the glass substrate 1 is carried into the device in a state that the NG surface information 3 is depicted directly on the substrate surface as shown in FIG. 1, an image of the substrate surface is taken using a camera such as a CCD camera to recognize the image, thereby grasping the recorded or not-recorded surface in accordance with the presence/absence of the NG surface information 3.

On the other hand, in the case that the recorded surface side information 11a and the not-recorded surface side information 11b are described on the containing cassette case 4 as shown in FIG. 2, an operator may input the orientation of the recorded or not-recorded surface into the recorded surface instructing device 34 when the glass substrate 1 is taken out of the containing cassette case 4 and set on the loader 39 without turning it to the other side. In addition, the operator may also input the orientation of the recorded or not-recorded surface into the recorded surface instructing device 34 on the basis of the recorded surface and/or not-recorded surface information described on the form(s) 12, 13 and/or 14 appended to the containing cassette case 4 as shown in FIGS. 3(a), 3(b) and/or 3(c).

Further, the recorded surface instructing device 34 may operate to read the bar code information 5 recorded in the seal put on the containing cassette case 4 using a bar code reader and inquire of the magnetic disk information management server 8 about the information to acquire the recorded or not-recorded information of the glass substrate contained in the containing cassette case 4 concerned, thereby grasping the recorded or not-recorded surface.

On the other hand, an unloader 35 is disposed in the exit chamber 28. The unloader 35 detaches a substrate 30 on which the base material, magnetic and protection layers have been formed using the sputtering device 20 for producing the magnetic recording medium and carries it to the outside of the sputtering device 20. Then, a lubrication layer is formed on the protection film of the substrate 30 by a dipping, spraying or a spin-coating method. A liquid lubricant consisting of a fluorine-based perfluoropolyether compound may be used as the material of the lubrication layer.

It becomes possible to deposit the dummy layer having the film stress which is made uniform with that on the recorded surface side on the side of the not-recorded surface in the above mentioned manner, without using an expensive material on the side of the not-recorded surface.

Description has been made using the device of the in-line system as the sputtering device 20 for producing the magnetic recording medium. However, it is also possible to use a sputtering device of a stationary opposing system that sputters a substrate which is in a stationary state relative to a target upon film-deposition.

The dummy layer is deposited on the non-recorded surface of the substrate simultaneously with deposition of the magnetic layer on the recorded surface of the substrate in the second sputter chamber 25. However, such a configuration is also possible that the magnetic layer and the dummy layer are deposited separately in different sputter chambers.

### INDUSTRIAL APPLICABILITY

The present invention is applicable to a magnetic disk substrate used in an HDD with a magnetic head disposed only on one side of a magnetic disk and its manufacturing method, and a magnetic disk using the magnetic disk substrate and its manufacturing method.

1. A magnetic disk substrate manufacturing method comprising an inspecting step of performing surface inspection to judge whether both main surfaces of a magnetic disk substrate meet conditions for forming a recording layer, wherein
with respect to a magnetic substrate in which one main surface meets the conditions and other main surface does not meet the conditions, discriminative information is appended to the other main surface.

2. A magnetic disk substrate manufacturing method comprising an inspecting step of performing surface inspection to judge whether both main surfaces of a magnetic disk substrate meet conditions for forming a recording layer and a packaging step of containing and packaging a plurality of magnetic disk substrates in which one main surfaces meet the conditions and other main surfaces do not meet the conditions in a case for shipment such that the main surfaces that meet the conditions are oriented in the same direction, wherein
in a state that recorded surface information indicating which one of the main surfaces of each substrate is a recorded surface that meets the conditions or not-recorded surface information indicating which one of the main surfaces of each substrate is a not-recorded surface that doe not meet the conditions is appended to the case for shipment, the recorded surface information or the not-recorded surface information is fed to a succeeding film-depositing step.

3. A magnetic disk substrate manufacturing method comprising an inspecting step of performing surface inspection to judge whether both main surfaces of a magnetic disk substrate meet conditions for forming a recording layer and a packaging step of containing and packaging a plurality of magnetic disk substrates in which one main surfaces meet the conditions and other main surfaces do not meet the conditions in a case for shipment such that the main surfaces that meet the conditions are oriented in the same direction, wherein
the case for shipment is made in advance correspond with recorded surface information indicating which one of the main surfaces of each substrate is a recorded surface that meets the conditions or not-recorded surface information indicating which one of the main surfaces of each substrate is a not-recorded surface that does not meet the conditions, and
the recorded surface information or the not-recorded surface information is fed to a succeeding film-depositing step without being appended directly to the magnetic disk substrate or the case for shipment.

4. A magnetic disk substrate having a recording layer formed on one main surface, wherein
information indicative of a not-recorded surface is appended to one main surface which does not meet conditions for forming a recording layer.

5. A magnetic disk manufacturing method, comprising:
a grasping step of grasping which one of both main surfaces of a magnetic disk substrate is a recorded or not-recorded surface; and
a film-depositing step of depositing a recording layer on a side of the recorded surface grasped at the grasping step and depositing a dummy layer for balancing film stresses on the both main surfaces on the not-recorded surface.

6. The magnetic disk manufacturing method according to claim 5, wherein the main surface to be used as the recorded surface is judged from information appended to the main surface of the magnetic disk substrate in the grasping step.

7. The magnetic disk manufacturing method according to claim 5, wherein the main surface to be used as the recorded surface is judged from the recorded surface or not-recorded surface information appended to a case for shipment containing a plurality of magnetic disk substrates in the grasping step.

8. The magnetic disk manufacturing method according to claim 5, wherein information which is made correspond with a case for shipment containing a plurality of magnetic disk substrates and which is recorded surface information indicating which one of the main surfaces of each substrate is a recorded surface that meets the conditions or not-recorded surface information indicating which one of the main surfaces of each substrate is a not-recorded surface that does not meet the conditions is obtained from relation with the case for shipment in which the magnetic disk substrate is contained in the grasping step.

9. The magnetic disk manufacturing method according to claim 5, wherein in the film-depositing step, the dummy layer is deposited using a material cheaper than a material of the recording layer.

10. A magnetic disk, comprising:
a magnetic disk substrate in which one main surface meets conditions for forming a recording layer and other main surface does not meets the conditions;
a recording layer formed on one main surface of the magnetic disk substrate that meets the conditions; and
a dummy layer formed on the other main surface of the magnetic disk substrate that does not meet the conditions so as to balance film stresses on the both main surfaces.

11. The magnetic disk manufacturing method according to claim 6, wherein in the film-depositing step, the dummy layer is deposited using a material cheaper than a material of the recording layer.

12. The magnetic disk manufacturing method according to claim 7, wherein in the film-depositing step, the dummy layer is deposited using a material cheaper than a material of the recording layer.

13. The magnetic disk manufacturing method according to claim 8, wherein in the film-depositing step, the dummy layer is deposited using a material cheaper than a material of the recording layer.
